(19) United States
(12) Patent Application Publication
(10) Pub. No.: US 2014/0062968 A1
(43) Pub. Date: Mar. 6, 2014

(54) MEASUREMENT OF SIGNAL GENERATED BY CONTACT OF INPUT DEVICE WITH SURFACE

(71) Applicant: TEN ONE DESIGN LLC, Montclair, NJ (US)

(72) Inventor: Peter James Skinner, Montclair, NJ (US)

(73) Assignee: TEN ONE DESIGN LLC, Montclair, NJ (US)

(21) Appl. No.: 13/889,595

(22) Filed: May 8, 2013

Related U.S. Application Data
(60) Provisional application No. 61/694,571, filed on Aug. 29, 2012.

(51) Int. Cl. G06F 3/0354

(52) U.S. Cl. CPC G06F 3/03545
USPC 345/179

(57) ABSTRACT

A system for measurement of a signal generated through interaction between a device and an electrically active surface member wherein a flexible conductive tip element supported by the device's body, when in contact with or proximity of the electrically active surface member, gives rise to a signal which is variable as a function of the contact area between the tip element and the surface member or of the proximity of the tip element to the surface member, and wherein there is circuitry to afford a grounding path for the flexible conductive tip element and to measure the signal; and further a method for measuring a signal resulting from such interaction.

### FIELD OF THE INVENTION

The present invention concerns the measurement of a signal generated by contact between a flexible electrically conductive or semi-conductive element and an electrically active surface member, such as the user interface (screen) for a tablet personal computer or hand-held data processing device.

### BACKGROUND OF THE INVENTION

Devices with electrically-sensitive user interfaces are becoming increasingly popular because they accommodate the incorporation of familiar pencil-and-paper functions into a user's interaction with the device. By way of example, a tablet personal computer allows a user to interact with the computer by writing on it, without sacrificing the power or utility of its operating system and/or various desktop applications. Simply put, users are able to take notes in their own handwriting, similar to taking handwritten notes with a pencil and paper, while still realizing the benefits of computerization. Moreover, users are able to interact directly with the regions of interest on a computer and thus more intuitively, as opposed to traditional computer input devices (mouses and trackpads) which do not interact directly with the screen and instead rely on a virtual representation (such as a cursor or arrow) to indicate screen position.

Devices with electrically-sensitive user interfaces are the foundation of many features incorporated in word processor and other personal computer software, for instance, the capability to share notes among meeting participants in real-time during the meeting via a wireless communication link. And there are additional advantages, such as the capability to search notes for particular words, and the capability to input information in other ways including speaking. These advances are beyond the capabilities of pencil and paper.

Users of tablet personal computers and other such devices commonly write on the device's display area with a stylus or pen. Measuring the force, sometimes referred to as pressure, exerted by the stylus on the device is useful in such connection. A change in this force (or pressure) can be utilized as a basis for varying of the width of a line drawn (e.g., character written), or modulation of the opacity or other attributes such as color of a displayed stylus stroke, in response to force exerted on a stylus during a drawing sequence. Force-measurement can also be the basis for validating the authenticity of a signature, insofar as capturing and storing force-measurement data makes unauthorized duplication of a signature more difficult. Still further uses are correlating the exerted force with an arbitrary change to objects on a computer display or values stored in computer memory caused by exertion of that force and controlling a computer three-dimensionally where the horizontal and longitudinal dimensions are reflected by the stylus' x and y coordinates, and a third dimension (e.g., depth) is reflected by the stylus' z coordinate which is determined by the signal correlating with force-measurement results. The latter methodology is helpful in navigating the virtual interface of a computer system, for example.

Existing methods for measuring the force with which a stylus contacts an electrically-sensitive user interface generally involve directly sensing the force exerted by the user on a stylus nib (also called a tip). The force is frequently described as acting in the longitudinal direction, alternatively referred to as the axial direction or “along the z-axis”. Thus, it is disclosed in various patents to measure the force a user's finger exerts on a stylus body as an alternative to the force exerted on the nib (sometimes referred to as “axial pressure”) or the force exerted normal to the z-axis (sometimes referred to as side-pressure).

By way of example, patents relating to measuring of force are U.S. Pat. Nos. 5,357,062, 5,438,275, 4,131,880, 5,565,632, 6,727,439, 5,004,871, and 7,202,862.

Conventional technologies, however, suffer from certain drawbacks and limitations. For instance, conventional pressure-sensing pen technologies may: require a mechanical actuator within the pressure-sensing device, which can lead to mechanical failure or be unhelpfully consumptive of room within an enclosure (pen body) that is generally very space-constrained; require precisely formed physical components that can have a high cost; under some circumstances (such as when drawing with a paintbrush), be unsuited to measure the interaction with a drawing surface, due to insensitivity (by way of example, a user may want to draw by lightly touching a drawing surface with the brush, but little or no pressure would be registered by a conventional sensor; or a user may want to draw a thick line by contacting the drawing surface with the side of the paintbrush bristles, but again little or no pressure would be registered by a conventional sensor). A new approach by which these and other shortcomings are remedied or at least mitigated would be a valuable advance.

### SUMMARY OF THE INVENTION

It is an object of the invention to provide a reliable and robust approach to measurement of a signal generated by urging a device against an electrically active surface.

It is another object of the invention to provide an approach to such measurement which yields accurate information concerning the measured signal.

It is still another object of the invention to provide an approach to such signal-measurement which is versatile in its adaptability to use with a wide range of electrically active surfaces.

It is yet another object of the invention to provide an approach to such signal-measurement which is cost-effective.

It is a further object of the invention to adapt the signal-measurement capability of the invention to determination of the force or pressure exerted on a device for urging it against the aforementioned surface to generate the measured signal.

These and other objects, as will be apparent from the following description, are met by the present invention.

Thus, in a first aspect, the invention is in a system for measurement of a signal generated as a consequence of effecting contact between a device and an electrically active surface member, which system comprises: a device body; a flexible resilient element supported by said device body, which element is electrically conductive or semi-conductive, whereby a signal can be generated through contact of the element with, or proximity of said device to, said member, and which element is furthermore variably deformable against said member such that a range of different contact areas can be effected, with said signal varying as a function of the contact area or the proximity of said device to said member; and circuitry that affords a grounding path for the flexible resilient element, and is operative to measure said signal.

In yet another aspect, the invention is in a method for measurement of a signal generated as a consequence of urging a device against, or effecting proximity of said device to, an electrically active surface member, which method comprises: providing a device having a device body and a flexible resilient element supported by said device body, said element being electrically conductive or semi-conductive such that a signal can be generated by contact of the element with, or proximity of the element to, the electrically active surface member, which signal is a function of the area of contact between the element and said member or proximity of said element to said member; further providing circuitry that affords a grounding path for the flexible element, and is operative to measure said signal; effecting contact between said element and the electrically active surface member so as to engender deformation of the element resulting in a particular area of contact between the element and said member, or effecting proximity of said element to said member, whereby a signal is generated as a function of said contact area or proximity; and measuring the signal.

The invention confers significant advantages on its practitioner. Utilization of a flexible, resiliently deformable conductive tip and a grounding and measurement circuit permit the simple and reliable measurement of the signal caused by urging of the device body to effect contact with or proximity to the electrically active surface member. The invention further involves relatively few or no moving parts, similarly allowing for more reliable and robust performance (e.g., a longer life cycle). Moreover, the invention is beneficially versatile in that it can be calibrated to work with a wide range of electrically active surface elements (such as touch sensors) for instance, by varying the characteristics of the measurement circuitry “on the fly” with complementary software or firmware to suit the particular need being addressed. And, on top of the foregoing, the invention can be implemented at relatively low cost, offering a competitive advantage over other measuring techniques. These and other features and advantages will be more fully explored in the following description of the invention.

### FIGURES OF DRAWING

FIG. 1 is a perspective view of a device body for urging a tip element against an electrically active surface.

FIG. 2 is side plan view of the device of FIG. 1.

FIG. 3 is a sectional view of the device of FIGS. 1 and 2 taken along the line 3-3 of FIG. 2.

FIG. 4 is an end plan view of a tip element supported by a device body of FIGS. 1-3.

FIGS. 5A through 5D are block diagrams of, respectively, four alternative circuitry configurations.

### DETAILED DESCRIPTION OF CERTAIN PREFERRED EMBODIMENTS

In various technologies, the mechanism for detecting force (or pressure) is self-contained. That is, the mechanism would work equally well pressed against a non-active surface as it would against, for instance, a computer display or active digitizing surface. Although in some cases, the active digitizing surface provides power to the stylus, so the assemblage would not work as intended outside of that environment, this is only because the necessary proper power to operate is missing.

The present invention is a system and method of measuring a signal as aforesaid, and optionally determining by inference therefrom some further parameters such as the force (or pressure) exerted on a device urged against an electrically active surface member to produce the signal, typically a signal generated by capacitive coupling of those two components. Thus, the present invention involves as key elements a conductive or semi-conductive flexible tip material for contact with the surface member, and circuitry that provides a grounding path for the flexible tip and is operative to measure the signal. The flexible tip material is conductive rubber in a preferred embodiment, but as will be discussed further hereinafter any conductive and flexible material, and numerous varied forms of such a tip, are suitable. Nonconductive materials can also be serviceable, so long as they are coated or otherwise combined with conductive materials sufficient to transfer charge.

The purpose of the flexible element (“tip element”) is to provide a contact area (with an electrically active surface) of one size reflecting a certain condition, and deflect to a second size when the condition changes. For instance, the size of the contact area can be a function of the amount of force or pressure applied to the tip element, preferably increasing smoothly and continuously with increasing force or pressure exerted. Alternatively, in other good embodiments of the invention contact area increases suddenly or in discrete increments with increasing force or pressure.

The tip element is formed of an appropriately resilient material. Moreover, the tip element material's conductive properties must be such that it can interact electrically with the electrically active surface. As mentioned in preceding passages hereof, the interface-contacting member's tip element comprises an electrically conductive or electrically semiconductive material. (Accordingly, such element is sometimes alternatively referred to herein as a “flexible resilient element” or a “flexible conductive tip element”.) In various good embodiments of the invention the tip element material is also one which exhibits an adequately low coefficient of friction between it and the surface that it slides easily over such surface.

However, the tip element material's resiliency and conductivity are necessary but not sufficient conditions for practicing the invention. That is to say, the tip element should also be deformable to afford different areas of contact between the tip element and the surface. To obtain this result in accordance with the invention, the tip element material itself must exhibit elasticity. And, in certain advantageous embodiments, the tip element incorporates one or more recesses into which the elastic material can expand to confer the desired deformability. (The aforementioned feature is not revealed through aspirational discussion in the prior art to the effect that under differing magnitude forces a tip deforms to provide variably sized areas of contact with the upper surface of a user interface's insulating layer, such area increasing as a function of an increasing manual force whereby the tip is pushed onto the upper surface of the insulating layer; nor is the feature put into possession of the art by notional observation that the signal provided to an associated signal detector increases in magnitude as a function of an increase in such contact area and the resulting increase in the capacitance value of a capacitor formed in part by such tip). The reliability of the signal varies with the tip element's capacity for deformation. The desired precision of response, which will enable dependably varying the area of contact between the tip element and the user interface as a function of the amount of force applied, requires the coincident utilization of a tip element material having proper mechanical and conductive properties; provision in the tip element of one or more recesses permitting internal material displacement, while optional, can prove quite helpful. More specifically, in combination with the previously discussed mechanical and conductivity properties, provision of a recess, preferably a plurality of recesses, in the tip element helps in securing the desired precision of response. The resilient elastic tip element material expands into the recess void space, thus aiding deformation and making the tip element more sensitive to differing levels of applied force in yielding different areas of contact with the interface.

Therefore, in accordance with the invention, the tip element material has mechanical properties which contribute to the selective attainment of different areas of contact depending on the force applied or other condition prevailing. This materially increases the reliability of attaining a desired area of contact, and the responsiveness of the tip element in yielding different areas of contact when subjected to changes in the force pressing the tip element against an electrically active surface, or whatever other condition is of interest.

The specific identity of the tip element material is not critical to the invention as long as the material has the desired mechanical properties to provide adequate resiliency and deformability for repeated pressing against the user interface surface such that a range of different areas of contact between the tip element and the interface can be attained, along with the desired conductivity properties to permit electrical interaction with the user interface. Such materials, in and of themselves, and their suitability for tip element formation are known. For instance, see U.S. Pat. No. 5,877,459, in which it is disclosed that many conductive elastomers are available for use as the tip element material. Thus, for instance, the tip element material can suitably be rubber or a resilient plastic in which particles of carbon or other electrically conductive or electrically semiconductive material are embedded. Similarly, in embodiments which further involve a sufficiently low coefficient of friction between the tip element material and the material of the surface member that the tip element slides easily over such surface member, the specific identity of the tip element material is not crucial—as long as its mechanical properties are adequate to confer the desired additional behavior as well. Once in possession of the teachings herein, those of ordinary skill in the art will be able to determine empirically a proper formulation for the tip element material. This will not require innovation rising to the level of further invention, and rather will be a matter of routine experimentation.

In highly preferred embodiments of the invention, the signal is generated as a result of capacitive coupling between the flexible tip element and the electrically active surface member. Accordingly, when the tip element is pressed against the surface the tip element material becomes a plate of and thereby forms a capacitor (as evident from the prior literature, such as the 459 Patent, a typical electrically-sensitive user interface, such as a digitizing tablet, will be understood by those skilled in the art as meaning a unit comprising an upper non-conductive surface and an underlying conductive layer, which acts as the capacitor's opposite plate). The condition, or a change in the condition, in respect of the thus-formed capacitor corresponds with generation of a related signal or change in signal.

The device body of the invention typically comprises a barrel or other tubular portion (commonly cylindrical, but cross-sections of other shapes can also be utilized) by which the device can be grasped. The tubular grasping portion may be hollow or solid. The member's barrel or other tubular portion can be formed of an electrically conductive or electrically semiconductive material, for instance, aluminum or other metal. This permits the barrel or other tubular portion to be electrically coupled to the tip element and/or the body of a user. Optionally, the barrel or other tubular portion's constituent conductive or semiconductive material can be covered by a non-conductive material, such as the coating produced by anodizing a metal. Alternatively, in certain good embodiments of the invention it is advantageous to form the barrel or other tubular portion of a non-conductive material, preferably covered by an electrically conductive or electrically semiconductive material.

It is noteworthy that a signal can be developed effectively not only when the device is in orientation normal to the surface member, but when the device is off-axis (touching at an angle). For example, with a rounded rubber tip element, that element deforms to afford suitable contact area even when addressing the surface at an angle, such as that used in a natural handwriting position. This is an advantage over standard implements which primarily work in a single axis. In connection with such feature, it is quite advantageous to configure the tip element so as to have a continuous convex interface-contacting surface. With this configuration, and the responsively deformable and resilient nature of the tip element material, especially in conjunction with the one or more recesses in the tip element, a desired contact area can be achieved at a range of angles between the flexible tip element and the electrically active surface, i.e., the angle of tilt. Moreover, as a consequence of those attributes, the desired contact area can readily be maintained even if the angle of tilt (between such member and the user interface surface) changes during use. This change frequently occurs because, when the device body (e.g., stylus body) is held in the hand of the user and there is contact with the surface, movement of the body can result in variation of the body's orientation vis-à-vis the surface from one moment to the next. But, even in the event the angle of tilt does change during use, the elasticity and resiliency of the tip element material, particularly if taken together with recesses in the tip element, are such that—while the constituent tip element material actually in contact with the interface surface may be adjusted (at least in part) to compensate—the overall area of contact between the tip element and the surface will remain constant or at least substantially constant.

The system and method are such that electrical fields can be sensed even before contact between the tip element and the electrically active surface. Thus, in some embodiments of the invention signal level can be used to ascertain proximity of the tip element to the surface. In any event, the flexible conductive tip element will first make contact with the touch sensor or other surface member over a small area. This small contact area will typically lead to generation of a correlatively lower level signal. In a preferred embodiment, the initial contact area is large enough for a meaningful signal to be generated, but in some other embodiments initial touch does not result in a contact area sufficient for generation of a measurable signal, and the signal does not register until a threshold area is reached. Preferably, an increasing surface area results in a smoothly increasing signal. That said, in alternative embodiments, an increase in signal is not continuous, but rather stepped in character.

Any tip element material configuration which allows for proper variation of contact area, and thus in preferred embodiments capacitive coupling, based on user actions is suitable. For example, a conductive fiber brush can be used. The brush will carry the capacitive coupling depending on how it is disposed on the electrically active (e.g., touch sensor) surface. If the brush tip element is barely touching, only a small signal is measured. If the brush contacts the surface sideways, a large signal is measured. A software application could use the signal to determine the amount of paint drawn on a display, making for a very compelling painting simulation. In this case, the signal is used more to determine contact area between the pen and the touch sensor, rather than force or pressure.

The second element noted above is circuitry that provides a grounding path for the flexible conductive tip element, enabling it to trigger the signal-generating interaction with the surface. Additionally, the circuit allows for the measurement of the strength of the signal resulting from capacitive coupling of the conductive elements of the electrically active surface member and the flexible conductive tip element. The signal strength measured at the flexible conductive tip element preferably varies continuously with varying force or pressure applied to—or other condition prevailing in respect of—the flexible conductive tip element.

The device body, e.g., stylus body, in one example, may be a grounding node. The means by which the body is grounded vary. The most common scenario involves a user holding the body in a bare hand. This method of grounding the body creates a low-impedance path for the high-frequency signal used in touch sensors and like surface members. A human body is typically sufficiently grounded to trigger a touch sensor. Another means of grounding the body is a direct or capacitive connection to a large conductive body, or to the surface member's own grounding node.

One example of implementing a circuit that can both ground and measure a signal from the surface member is to place a fixed impedance from the flexible conductive tip element to the device body. A small amount of current will travel from the flexible conductive tip element through the impedance to the grounded body. A voltage will develop over the impedance, and a high-impedance measuring circuit can be used to detect the developed voltage. The voltage will vary linearly with the amount of current conducted to (or from) the body. At this point, because the signal is capacitively coupled it will appear as an AC signal with respect to the body, and will appear from that reference to change rapidly between a positive and negative voltage.

If the value of the impedance is low enough (for example, 100 ohms), the flexible conductive tip element will be well grounded, and the device body will have little difficulty triggering the touch sensor. If the value of the impedance is too high (for example, 5 megohms), the flexible conductive tip element will not be well grounded, and it will be difficult to trigger the interaction sought. It is important to choose a value that will properly ground the flexible conductive tip element, yet develop a voltage high enough to measure meaningfully.

An analog to digital converter is commonly used to measure signals. Another commonly used device is known as an RMS to DC converter. This device measures the absolute value of the average signal amplitude and outputs that value as a DC voltage. The resulting DC voltage is typically measured with an analog to digital converter.

A variety of circuit configurations can be used to measure the signal at the flexible conductive tip element. One particularly compelling circuit configuration includes a rectification stage that either inverts the negative portion of the signal or removes the negative portion of the signal, followed by an integration stage that continuously sums the rectified voltage signal over a specified time. At the end of the specified time, the sum (in the form of a voltage or a number stored in a computing environment) is used to represent the strength of the signal received over the specified time. This is similar in operation to an RMS to DC converter, and such a converter may be used in the place of this circuit configuration to perform a similar function.

In various other good embodiments a measurement involves or conditioning system processes only a portion of a signal that is generated at the flexible conductive tip element. This adaptation is useful for instance in respect of voltage signals generated through interaction with an electrically active surface, those signals being generally periodic. Thus, it is advantageous in some cases to select a portion of a voltage signal based on its temporal position within such period. As an example, if the first half of the signal is not useful or would contaminate the overall measurement, it may be ignored in favor of the second half. The portion may be chosen by selecting signal components that appear within a given time range or signal components that appear within a given voltage range. The practitioner may select signal components using analog processing, digital processing, or a combination of analog processing and digital processing. And in yet other good embodiments the signal generated at a flexible conductive tip element when it is making contact with one location on an electrically active surface member differs from the signal generated at the flexible conductive tip element when it is making contact with a second location on that electrically active surface member. The invention's practitioner can therefore in some cases obtain information related to the location of the flexible conductive tip element along one or more axes within or normal to the plane of the electrically active surface member by analyzing the signal generated at the flexible conductive tip element relative to reference or other signals generated at the tip element when it is making contact with different locations on the electrically active surface member.

Many alternative circuit configurations can be used to condition, filter, measure, and ground the signal generated at the flexible conductive tip element, depending on prevailing conditions, and the parameters sought to be evaluated. The circuit configuration implemented in any single embodiment can be arranged or configured as necessary or advantageous to satisfy design priorities. The circuit configurations described here are representative of a class of configurations that perform the disclosed function. When in possession of the teachings herein, one of ordinary skill will be able to devise circuit configurations for implementing them without the need for further invention.

For instance, additional components which are individually known, in the nature of modules, for achieving various of the desired or optional functions include but are not limited to a voltage-doubler (also known as an RF detector) circuit that uses diodes and capacitors to increase the amplitude of a small AC voltage, a low-pass filter stage that performs a function similar to an integrator, a peak-hold circuit that detects the maximum value of a voltage, and an amplification stage, to change the amplitude of a voltage. Similarly, individually known digital signal processing modules may be used, in combination with each other and the further features of the invention, to condition, amplify, filter, integrate, or otherwise modify a discrete signal. Typically, circuitry design is driven or at least partially influenced by cost and availability of parts, by the nature of other components and by the difficulty of implementation. With that in mind, the alternatives described herein afford abundant direction on how to achieve the desired objective but still stay within a reasonable budget. As indicated heretofore, once in possession of the present invention, one of ordinary skill in the art will be able to incorporate those modules and/or responding functions as a matter of routine experimentation.

One prominent benefit of the foregoing is that there are very few required components. For instance, the circuitry in a preferred embodiment comprises a microprocessor with a built-in analog to digital converter and operational amplifier, as well as external components made principally of a few diodes, capacitors, resistors, and a connector to make electrical contact with the tip element. This simplicity leads to a low manufacturing cost, and reliable, durable performance due to the reduction in number of parts, and especially moving parts, when practicing the invention.

In further good embodiments, the present invention is capable of detecting when the flexible conductive tip element is actually in contact with the electrically active surface member. This “tip-down” (used herein as shorthand for element-down) detection can be useful to control behavior of both the stylus and software running on any associated circuitry. In such connection, the stylus can contain electrical circuitry that can be placed in low-power mode when the tip element is not in contact with the surface member. When contact is initiated, the electrical circuitry can be taken out of low-power mode and begin measuring input data.

Another application of tip-down detection is to correlate the tip-down event with a touch event on the associated computing device. If a touch can be correlated with a tip-down event, software on the associated computing device can determine with certainty that the touch event was caused by the stylus or other device, and not a human finger or human palm resting on electrically active surface member. In practice, the ability to discriminate between “touch” by a stylus or other device and any other type of touch can be the basis of a computing system's responding to touch by a stylus or other device in one fashion, and to any other type of touch in another fashion. One example is a note-taking application's ignoring all touches except for touch by a stylus or device. In this manner, a user may rest his hand on the touch sensor without fear of creating accidental stylus drawing behavior within the note-taking application.

A further and highly significant application of the invention is the determination (inferentially) of the force or pressure applied to a device body (e.g., a stylus) in urging the flexible conductive tip element against an electrically active surface member. Embodiments of this application involve the innovative signal-measurement technology described in preceding paragraphs hereof, and the further incorporation of circuitry relating information about the extent of contact between the aforementioned tip element and surface member, and corresponding signal, with such force or pressure calculated to produce same. In effect, the signal-measurement enabled by the invention gives rise to data which can be fed to a processing function that from it computes a corresponding force or pressure.

To that end wired or wireless communication can be utilized to transfer the signal-measurement data to a remote computer facility for further analysis and generation of derivative parameter data. Data concerning calculated force or pressure, or any other parameter derivable from the signal value, can also be transferred via wired or wireless communication, for example, to a portable device. The wired or wireless connection can be implemented with light waves, sound waves, magnetic fields, electromagnetic fields, or any other suitable conventional medium. A wireless radio connection is convenient, and thus preferable, for transferring data to an associated computing device.

It will be appreciated that the data secured by way of signal-measurement in accordance with the invention can also—via a different processing package—be utilized to calculate other parameters relatable to the signal generated by contact between the tip element and the electrically active surface member. Examples of these parameters are button press data, acceleration data, temperature data, gps location data, light sensor data, gyroscopic data, magnetometer data, and photographic data. This further processing function can comprise additional computing components (including suitable software) integrated with the components by which signal-measurement is achieved. Alternatively, the determination of such force or pressure can be carried out by means of a remotely situated computer.

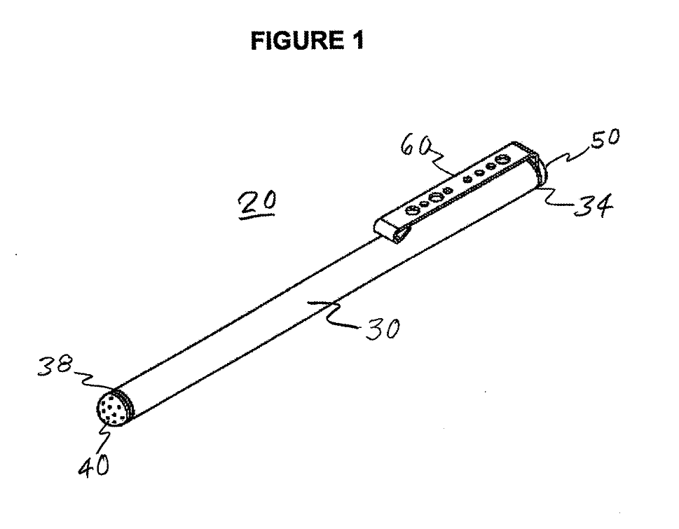

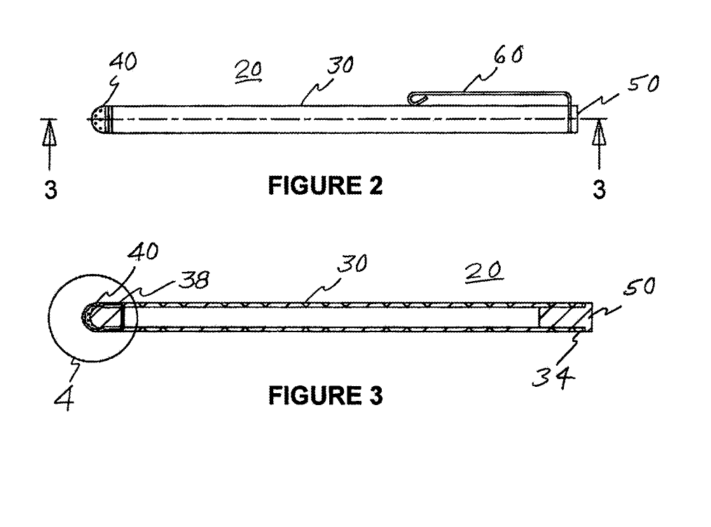

With reference to FIG. 1, a device 20 for inputting data to an electrically-sensitive user surface is shown in perspective. FIG. 2 is a side plan view of the device 20. The device 20 comprises a tubular body 30 having a proximal end 34 and a distal end 38, tip element 40 affixed to the distal end 38 of the body 30, a cap 50 affixed to the proximal end 34 of the body 30 and a pocket-clip 60 retained between the proximal end 34 of the body 30 and the cap 50. From the sectional view of FIG. 3, it will be seen that the cap 50 as well as the surface-contacting member 40 are received within the proximal end 34 and the distal end 38, respectively, of the tubular body 30. In certain embodiments, the cap 50 and the surface-contacting member 40 are retained by press-fitting them within the respective ends 34 and 38 of the body 30.

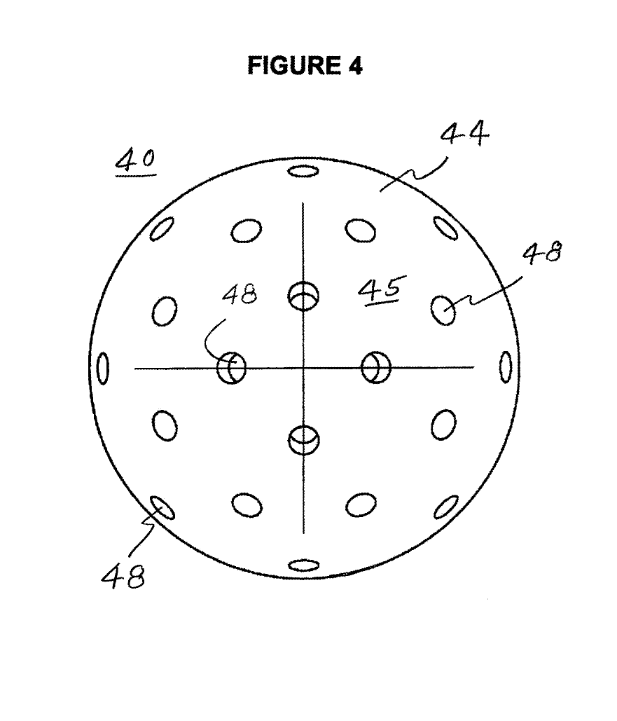

With reference also to FIG. 4, a plurality of holes 48 extend from an outer surface 45 of the generally hemispherical portion 44 through an inner surface 43 thereof. Holes 48 are generally evenly distributed throughout portion 44.

In use, the tubular body 30 of device 20 is held between the fingers of a user, much like a pen or pencil, with the distal end 38 of the body 30 and tip element 40 pointing towards an electrically active surface of a data processing device (such as a computer, mobile telephone, hand-held unit, or the like). When the user has determined where to contact the surface, he or she presses tip element 40 against its surface. Tip element 40 comprises a resilient material, so that its outer surface 45 deforms when pressed against the electrically active surface in order to conform to such surface. The holes 48 in the outer, generally hemispherical portion 44 of tip element 40 permit the resilient material to expand within such holes, thus facilitating deformation of the outer surface 45 to conform to the electrically active surface. Accordingly, an adjustment in the force by which tip element 40 is urged against the surface leads to a change in the area of contact between tip element 40 and such surface.

In certain embodiments, the outer, generally hemispherical portion 44 of tip element 40 is provided with one or more indentations which do not extend entirely through the portion 44, while in other embodiments the indentations extend entirely there-through. In certain embodiments, tip element 40 is solid, rather than hollow. In certain embodiments, the portion 44 is convex, but not hemispherical. For example, in certain ones of such embodiments portion 44 has a generally elliptical, hyperbolic, parabolic or multifaceted shape.

In those embodiments of the device 20 suitable for capacitive coupling with the surface tip element 40's electrically conductive or electrically semiconductive material forms a plate of a capacitor when urged against the electrically-acting surface. In certain ones of such embodiments, tip element 40 comprises rubber or resilient plastic having carbon or other electrically conductive or semiconductive particles embedded therein, or comprises a nonconductive material coated with an electrically-conductive or semiconductive material. In other embodiments tip element 40 may comprise an electrically-conductive or semiconductive material with a non-conductive coating used, for example, to adjust the coefficient of friction, add color, or add texture. In such an embodiment, the non-conductive coating must be thin enough and/or exhibit a high enough relative permittivity for an adequate signal to be generated and conducted to the signal-measurement function. Tip element 40 may be produced, for example, by injection molding. In certain ones of such embodiments, the tubular body 30 is made of an electrically-conductive or semiconductive material, for example, aluminum or other metal, such that it is electrically coupled tip element 40 and to the user's body through his or her fingers. In certain ones of such embodiments in which the tubular body 30 is made of an electrically-conductive or semiconductive material, this material is covered by a non-conductive material, such as a coating produced by anodizing a metal. In certain ones of such embodiments, the tubular body 30 is made of a non-conductive material coated with an electrically-conductive or semiconductive material.

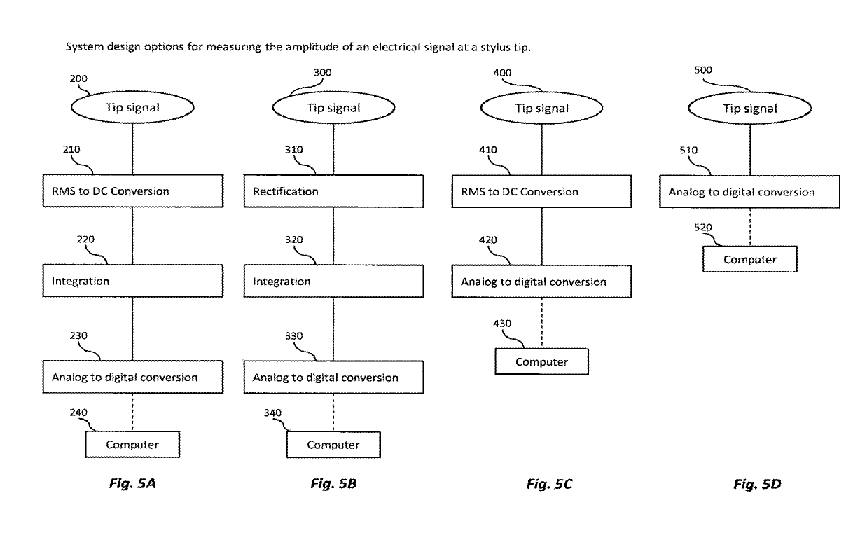

In FIGS. 5A through 5D there are depicted, in block diagram format, several alternative configurations for implementing signal-measurement in accordance with the invention. From the configuration of FIG. 5a it can be seen that a signal 200, generated at the tip element, is conducted to element 210 which is an RMS to DC converter. This converter measures the absolute value of the average signal amplitude, and provides output in the form of a corresponding DC voltage. That voltage signal is then conducted to integration unit 220, where the voltage signal is continuously summed over a specified period of time. At the end of that period, the sum is conducted to element 230, which is an analog to digital converter. Another suitable configuration is shown in FIG. 5B. In such configuration, tip signal 300 is conducted to rectifier 310, which either inverts or removes the “negative” portion of the signal. Thereafter, the output from the rectifier is conducted to integration unit 320 and that output in turn to analog to digital converter 330, which function in the manner described above for components of that sort. FIG. 5C represents a more basic approach wherein tip signal 400 is conducted to RMS to DC converter 410 and the output is conducted to analog to digital converter 420, the functions of the components being as described elsewhere herein. Lastly (but not exhaustively), FIG. 5D is directed to a “stripped down” configuration in which tip signal 500 is conducted directly to analog to digital converter 510, forgoing much of the signal processing applied the other configurations. In each of the configurations, wired or wireless connection to a computer facility (240, 340, 430, 520) for calculating force/pressure on the device body, or some other parameter of interest, is shown via dashed-line connection.

While the invention in a number of different aspects has been disclosed in various forms, and although various embodiments have been described with reference to a particular arrangement of parts, features and the like, these are not intended to exhaust all possible aspects, arrangements or features, and indeed many other aspects, embodiments, modifications and variations will be ascertainable by those of skill in the art. Therefore, modifications, additions and deletions can be made (as long as the essential elements of the invention or substitutes are preserved) without departing from the spirit and scope of the system and method and their respective equivalents, set forth in the following claims.

What is claimed is:

1. A system for measurement of a signal generated as a consequence of effecting contact of a device with, or proximity of said device to, an electrically active surface member, which system comprises:
a device body;
a flexible resilient element supported by said device body, which element is electrically conductive or semi-conductive, whereby a signal can be generated through contact of the element with, or proximity of said device to, said member, and which element is furthermore variably deformable against said member such that a range of different contact areas can be effected, with said signal varying as a function of the contact area or the proximity of the element to said member; and
circuitry that affords a grounding path for the flexible resilient element, and is operative to measure said signal.

2. The system as defined in claim 1, which further comprises circuitry for determining from said signal measurement the force with which said device body is urged against the electrically active surface member.

3. The system as defined in claim 1, wherein the flexible resilient element comprises an elastic material which is deformable as a result of its being pressed against the electrically active surface.

4. The system as defined in claim 3, wherein the flexible resilient element material incorporates one or more recesses into which the elastic material can expand.

5. The system as defined in claim 4, wherein the recesses extend through the flexible resilient element material from an exterior surface to an interior surface.

6. The system as defined in claim 1, wherein the flexible resilient element comprises electrically conductive or semi-conductive material, such that it can interact electrically with the electrically active surface.

7. The system as defined in claim 6, wherein the flexible resilient element material further has mechanical properties which contribute to the selective attainment of different areas of contact as a function of the force applied to the device body.

8. The system as defined in claim 7, wherein the flexible resilient element material further exhibits an adequately low coefficient of friction between itself and the electrically active surface member it slides easily over the surface element.

9. A system for measurement of a signal generated as a consequence of effecting contact of a device with, or proximity of said device to, an electrically active surface member, which system comprises:
a device body;
a flexible resilient element supported by said device body, which element is electrically conductive or semi-conductive, whereby a signal can be generated through contact of the element with, or proximity of said device to, said member, and which element is furthermore variably deformable against said member such that a range of different contact areas can be effected, with said signal varying as a function of the contact area or the proximity of the element to said member; and
circuitry that affords a grounding path for the flexible resilient element, and is operative to process only a portion of the signal generated at the flexible resilient element in connection with measuring said signal.

10. A method for measurement of a signal generated as a consequence of effecting contact of a device with, or effecting proximity of said device to, an electrically active surface member, which method comprises:
providing a device having a device body and a flexible resilient element supported by said device body, said element being electrically conductive or semi-conductive such that a signal can be generated by contact of the element with, or proximity of the element to, the electrically active surface member, which signal is a function of the area of contact between the element and said member or proximity of said element to said member;
further providing circuitry that affords a grounding path for the flexible element, and is operative to measure said signal;
effecting contact between said element and the electrically active surface member so as to engender deformation of the element resulting in a particular area of contact between the element and said member, or effecting proximity of said element to said member, whereby a signal is generated as a function of said contractor proximity of said element to said member;
measuring the signal.

11. The method as defined in claim 10, which further comprises, determining from said measured signal the force with which said device body is urged against the electrically active surface.

12. The method as defined in claim 10, which further comprises rectifying the signal so measured to convert or remove the negative portion of the signal, and summing the rectified signal over a specified time.

13. The method as defined in claim 10, wherein the signal is subjected to analog processing, digital processing or a combination of analog and digital processing.

14. A method for measurement of a signal generated as a consequence of effecting contact of a device with, or effecting proximity of said device to, an electrically active surface member, which method comprises:
providing a device having a device body and a flexible resilient element supported by said device body, said element being electrically conductive or semi-conductive such that a signal can be generated by contact of the element with, or proximity of the element to, the electrically active surface member, which signal is a function of the area of contact between the element and said member or proximity of said element to said member;
further providing circuitry that affords a grounding path for the flexible element, and is operative to measure said signal;
effecting contact between said element and the electrically active surface member so as to engender deformation of the element resulting in a particular area of contact between the element and said member, or effecting proximity of said element to said member, whereby a signal is generated as a function of said contact or proximity of said element to said member; and
processing only a portion of the signal generated at the flexible resilient element in connection with measuring said signal.

15. The method as defined in claim 14, which comprises analyzing only the signal generated during a given time interval or within a given signal range.
